(19) United States
(12) Patent Application Publication
(10) Pub. No.: US 2016/0027118 A1
(43) Pub. Date: Jan. 28, 2016

(54) SYSTEM AND METHOD FOR CREATING INSURANCE BUNDLE RECOMMENDATIONS

(71) Applicant: STATE FARM MUTUAL AUTOMOBILE INSURANCE COMPANY, Bloomington, IL (US)

(72) Inventors: Jason Freeck, Gurnee, IL (US); Ryan T. Schmidt, Bloomington, IL (US); Paul Sloan, Byron, IL (US); Neel Kothari, Aurora, IL (US); Alex E. Ford, Chicago, IL (US); Mihir D. Angal, San Jose, CA (US)

(21) Appl. No.: 14/339,257

(22) Filed: Jul. 23, 2014

(51) Int. Cl. G06Q 40/08; G06Q 30/06

(52) U.S. Cl. CPC G06Q 40/08; G06Q 30/0631

(57) ABSTRACT

A system and method may create personalized insurance bundle recommendations to a user based on survey data about the user and historical data related to the user. Survey data, gathered from user questionnaires and information databases, may be analyzed to determine a similar customer list based on demographic information. The similar customer list may then be analyzed to determine insurance coverage that may be appropriate for the user. Two or more policy types may then be packaged and presented to the user as an insurance bundle.

### FIELD OF THE DISCLOSURE

This disclosure relates to a system and method for bundling different types of insurance policies based on demographic and other information.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An insurance bundle is a combination of insurance products that comprehensively protect a customer. For example, an insurance bundle may include auto insurance, renters insurance, and motorcycle insurance from the same provider and often at a discounted cost compared to purchasing each product individually. Bundled insurance packages are becoming increasingly popular because they simplify coverage for customers and also generate revenue for insurance providers. With the popularity of insurance bundles rising, there exists a need to provide customers with quick and personalized bundle packages.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A bundle recommendation tool may provide a resource for customers and may facilitate sales for an insurance provider. Additionally, customers may be attracted to insurance providers by the convenience and savings provided by insurance bundling. An existing customer may choose to consolidate their insurance needs with one provider if offered insurance product in bundles. In some embodiments, an insurance bundling tool may provide comprehensive personalized insurance bundles to a customer.

For example, an embodiment may include a method implemented by a computer. The method may receive user data and the computer may use it to determine one or more recommended insurance bundles. For example, the method may communicate a questionnaire to a customer. The questionnaire may include a plurality of demographic questions such as age, sex, occupation, income, etc. The method may also receive user insurance history, purchase history, or other data related to the user from a database. The method may then transform the received survey data into a similar customer list. The similar customer list may be then used to determine the most appropriate bundles for the user based on popularity of coverage within the similar customer list or based on other common characteristics of the received data and the bundles. The method may also analyze the user demographic data to determine types of coverage that are appropriate for the user based on the demographic data. The method may then present a list of insurance bundles that may be sorted based on each bundle's relevance to the user and the received data corresponding to the user. The insurance policies of the insurance bundles may correspond to insurance policies purchased by one or more customers of the similar customer list. The method may also allow users to optionally edit the bundles based on their own preferences, and purchase a selected insurance bundle.

In other embodiments, a computer device may receive user data and use it to determine one or more recommended insurance bundles. The computer device may comprise one or more processors and one or more memories coupled to the one or more processors. The one or more memories may include computer executable instructions stored therein that, when executed by the one or more processors, cause the one or more processors to perform a plurality of functions. For example, the functions may cause the one or more processors to communicate a questionnaire to a customer. The questionnaire may include a plurality of demographic questions such as age, sex, occupation, income, etc. The functions may also cause the one or more processors to receive user insurance history, purchase history, or other data related to the user from a database. The functions may then cause the one or more processors to use the received survey data to create a similar customer list. The similar customer list may be used to determine the most appropriate bundles for the user based on popularity of coverage within the similar customer list or based on other common characteristics of the received data and the bundles. The functions may cause the one or more processors to then analyze the user demographic data to determine types of coverage that are appropriate for the user based on the demographic data. The functions may cause the one or more processors to present a list of insurance bundles that is sorted based on each bundle's relevance to the user and the received data corresponding to the user. The insurance policies of the insurance bundles may correspond to insurance policies purchased by one or more customers of the similar customer list. The functions may also cause the one or more processors to allow users to optionally edit the bundles based on their own preferences, and purchase a selected insurance bundle.

In still other embodiments, a tangible computer-readable medium may include non-transitory computer readable instructions stored thereon to receive user data and use it to determine one or more recommended insurance bundles. The instructions may comprise communicating a questionnaire to a customer. The questionnaire may include a plurality of demographic questions such as age, sex, occupation, income, etc. The instructions may also comprise receiving user insurance history, purchase history, or other data related to the user from a database. The instructions may then comprise using the received survey data to create a similar customer list. The similar customer list may be used to determine the most appropriate bundles for the user based on popularity of coverage within the similar customer list or based on other common characteristics of the received data and the bundles. The instructions may also comprise analyzing the user demographic data to determine types of coverage that are appropriate for the user based on the demographic data. The instructions may then present a list of insurance bundles that is sorted based on each bundle's relevance to the user and the received data corresponding to the user. The insurance policies of the insurance bundles may correspond to insurance policies purchased by one or more customers of the similar customer list. The instructions may also allow users to optionally edit the bundles based on their own preferences, and purchase a selected insurance bundle.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a simplified and exemplary block diagram of a system for creating and presenting insurance bundle recommendations;

FIG. 2. is an exemplary architecture of a server of a system for creating and presenting insurance bundle recommendations;

FIG. 3. is a flow chart illustrating an exemplary method for a front end user experience for an insurance bundle recommendation application;

FIG. 4. is an exemplary user data survey according to one embodiment of the present invention;

FIG. 5. is a flow chart illustrating an exemplary method for receiving, gathering, and analyzing user data to create and present insurance bundle recommendations to the user;

FIG. 6. is an exemplary display of bundle recommendation results;

FIG. 7. is a flow chart illustrating an exemplary method for user editing of insurance bundle recommendations according to one embodiment of the present invention;

FIG. 8. is an exemplary user interface for editing bundle packages; and

FIG. 9. illustrates a block diagram of a computer to implement the various user interfaces, methods, functions, etc., for creating and presenting insurance bundle recommendations in accordance with the described embodiments.

The figures depict embodiments of the present invention for purposes of illustration only. One skilled in the art will readily recognize from the following discussion that alternate embodiments of the structures and methods illustrated herein may be employed without departing from the principles of the invention described herein.

### DETAILED DESCRIPTION

Although the above text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term “ ” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

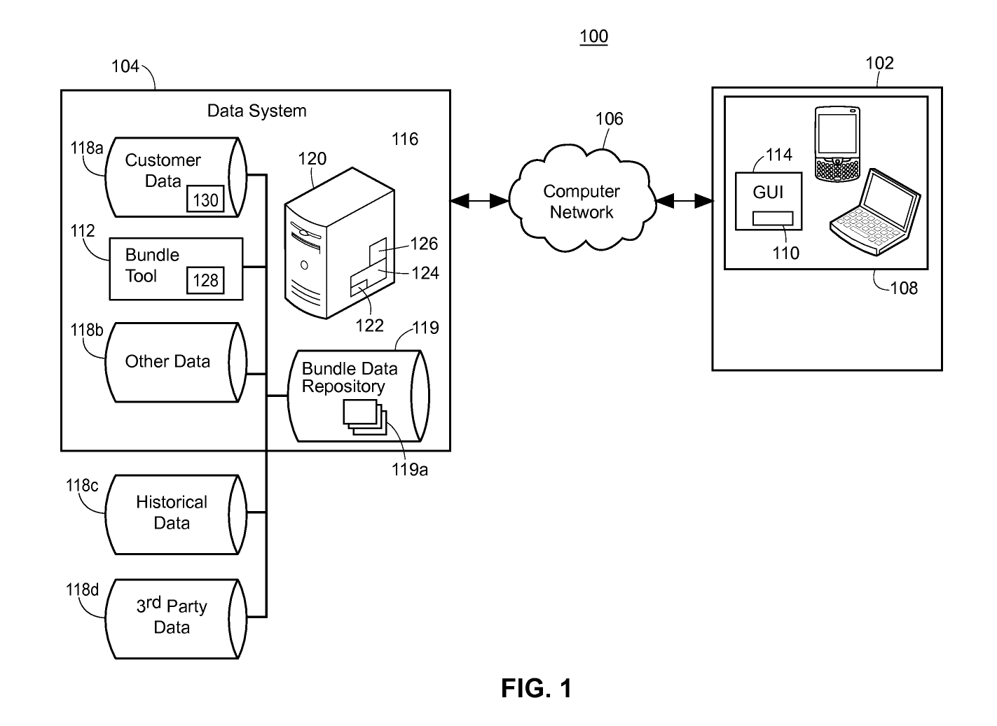

FIG. 1 generally illustrates one embodiment for a system 100 to create and present an insurance product to a customer, the product including a plurality of policies, lines, coverage, and other items (i.e., an insurance bundle). The system 100 may include front end components 102 and backend components 104 in communication with each other via a communication link 106 (e.g., computer network, internet connection, etc.). FIG. 1 illustrates a block diagram of a high-level architecture of a bundle creation and presentation system 100 including various software or computer-executable instructions and hardware components or modules that may employ the software and instructions to create and present insurance bundles. The various modules may be implemented as computer-readable storage memories containing computer-readable instructions (i.e., software) for execution by a processor of the computer system 100. The modules may perform the various tasks associated with creating and presenting insurance bundles, as herein described. The computer system 100 also includes both hardware and software applications, as well as various data communications channels for communicating data between the various hardware and software components.

The insurance bundle creation and presentation system 100 may include various entities at the front end 102 that may communicate survey data to the backend components 104 to complete bundle creation and presentation. For example, the front end components 102 may include a computing device 108 that is capable of executing a graphical user interface (GUI) 110 for a bundle tool 112 within a web browser 114. In some embodiments, a computing device 108 executes instructions of a network-based data system 116 to receive customer data 118a, other data 118b, historical data 118c and third party data 118d at the front end components 102 via the computer network 106 for display in the GUI 110. The backend components 104 may receive the data 118a, 118b, 118c, 118d from the front end components 102 via the computer network 106 from execution of a bundle tool 112. The bundle tool 112 may create bundles 119a and cause the bundles 119a to be stored in a bundle data repository 119. Generally, each bundle 119a is a data structure comprised of a plurality of data to be presented to the user.

The computing device 108 may include a personal computer, smart phone, tablet computer, or other suitable computing device. The GUI 110 may communicate with the system 116 through the Internet 106 or other type of suitable network (local area network (LAN), a metropolitan area network (MAN), a wide area network (WAN), a mobile, a wired or wireless network, a private network, a virtual private network, etc.). A system server 120 may send and receive information and data 118a, 118b, 118c, 118d for the system 100 such as computer-executable instructions and data associated with applications executing on the computing device 108 (e.g., the bundle tool 112). The applications executing within the system 100 may include cloud-based applications, web-based interfaces to the data system 116, software applications executing on the computing device 108, or applications including instructions that are executed and/or stored within any component of the system 100. The applications, GUI 110, browser 114, and tool 112 may be stored in various locations including separate repositories and physical locations.

In some embodiments, the data system 116 in general and the server 120 in particular may include computer-executable instructions 122 stored within a memory 124 of the server 120 and executed using a processor 126. The instructions 122 may instantiate a bundle tool 112 or send instructions to the computing device 108 to instantiate a GUI 110 for the tool 112 using a web browser application 114 of a computing device 108. In some embodiments, the browser application 114, GUI 110, bundle tool 112, and elements of the data system 116 may be implemented at least partially on the server 120 or the computing device 108. The data system 116 and processor 126 may execute instructions 122 to display the GUI 110 including the data 118a, 118b, 118c, 118d within a display of the computing device 108. The GUI 110 may allow a user to access various data 118a, 118b, 118c, 118d within the data system 116, edit or add data to the system 100, and other actions with the system data.

The bundle tool 112 may include survey data 128 gained through a detailed customer study. The system 100 may receive the survey data 128 through an on-line environment (e.g., the computing device 108) and web-based user interface, as further described herein. The system 100 may also receive additional survey data 128 from customer data 118a, other data 118b, historical data 118c, or third party data 118d when appropriate.

The bundle tool 112 may include various instructions for execution by a processor 126 to create bundles. For example, the tool 112 may create bundles by using the user demographic data from a completed survey 128 to identify a similar customer list 130 within the customer data 118a. A similar customer list 130 may then be analyzed by the bundle tool 112 to provide information about which types of insurance are most popular with those customers and, thus, most relevant to the user. The bundle tool 112 may then package the most popular types of coverage from the similar customer list 130 into one or more insurance bundles 119a, 1119b, 119c, etc. and present them to the user. Alternatively, the bundle tool 112 may create a bundle 119a by comparing a user's previous insurance purchases from survey data 128 with current coverage from 118a, 118c and 118d to determine which types of coverage are most relevant to a user. The bundle tool 112 may then package the coverage into one or more bundles 119a for presentation. The tool 112 may also execute the various instructions described herein in combination with other instructions to create bundles 119a which may be ranked for relevance to a user and to present the insurance bundles to the user.

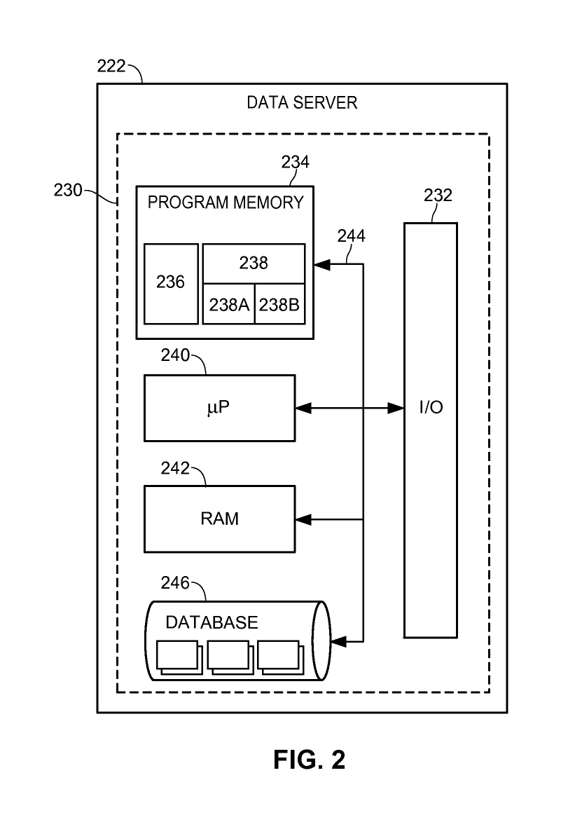

Referring now to FIG. 2, a data server 120 includes a controller 230. The controller 230 includes a program memory 234, a microcontroller or a microprocessor (P) 240, a random-access memory (RAM) 242, and an input/output (I/O) circuit 232, all of which are interconnected via an address/data bus 244. The program memory 234 may store computer-executable instructions, which may be executed by the microprocessor 240. In some embodiments, the controller 230 may also include, or otherwise be communicatively connected to, a database 246 or other data storage mechanism (one or more hard disk drives, optical storage drives, solid state storage devices, etc.). The database 246 may include data such as customer questionnaires, etc. It should be appreciated that although FIG. 1 depicts only one microprocessor 240, the controller 230 may include multiple microprocessors 240. Similarly, the memory 234 of the controller 230 may include multiple RAMs 236 and multiple program memories 238, 238A and 238B storing one or more corresponding server application modules, according to the controller's particular configuration.

Although FIG. 2 depicts the I/O circuit 232 as a single block, the I/O circuit 232 may include a number of different types of I/O circuits (not depicted), including but not limited to, additional load balancing equipment, firewalls, etc. The RAM(s) 236, 242 and the program memories 238, 238A and 238B may be implemented in a known form of computer storage media, including but not limited to, semiconductor memories, magnetically readable memories, and/or optically readable memories, for example, but does not include transitory media such as carrier waves.

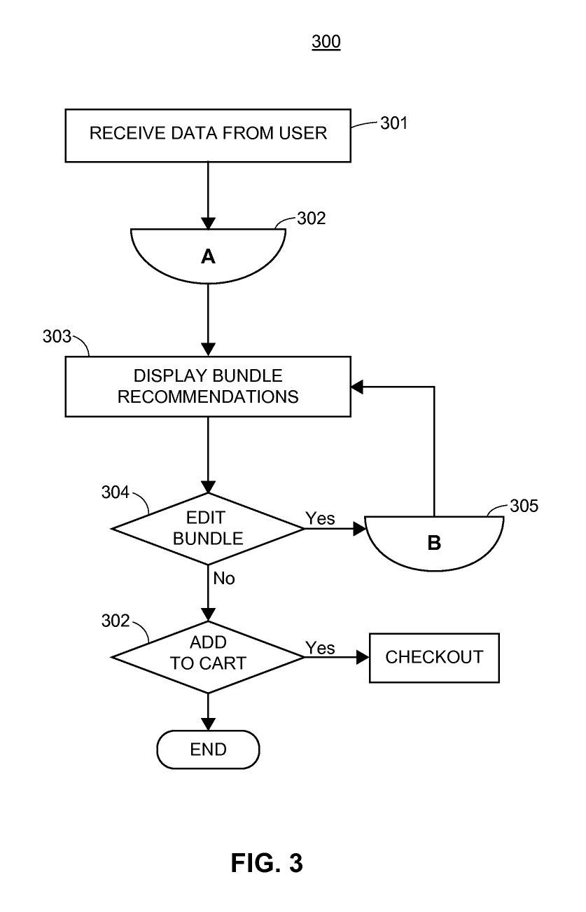

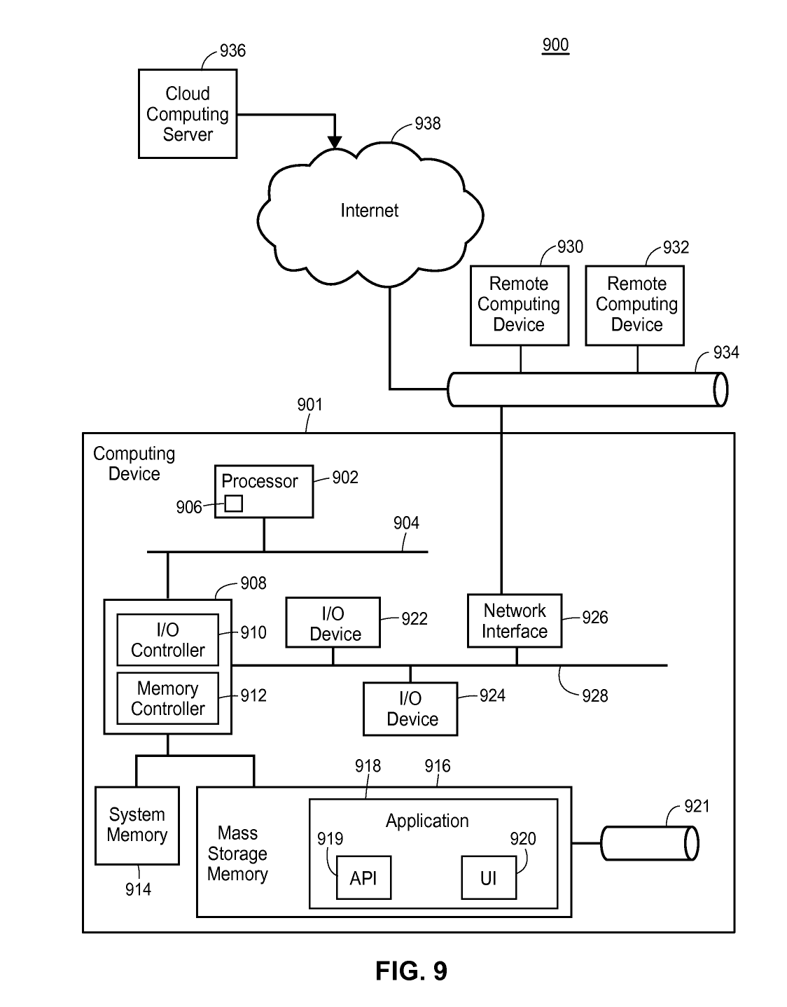

With reference to FIG. 3, the system 100 described herein may be employed in a method 300 (FIG. 3) to receive data corresponding to a customer to be used in creating and presenting insurance bundle 119a recommendations to the customer. The method 300 may include one or more functions or routines in the form of non-transitory computer-executable instructions that are stored in a tangible computer-readable storage medium and executed using a processor of a computing device (e.g., the computing device 102, the server 120, or any combination of computing devices within the system 100). The routines may be included as part of any of the modules described in relation to FIG. 1, above, or FIG. 9, below, or as part of a module that is external to the system illustrated by FIGS. 1 and 9. For example, the method 300 may be part of a browser application or another application running on the computing device 102 as a plug-in or other module of the browser application. Further, the method 300 may be employed as “software-as-a-service” to provide a computing device 102 with access to the data system.

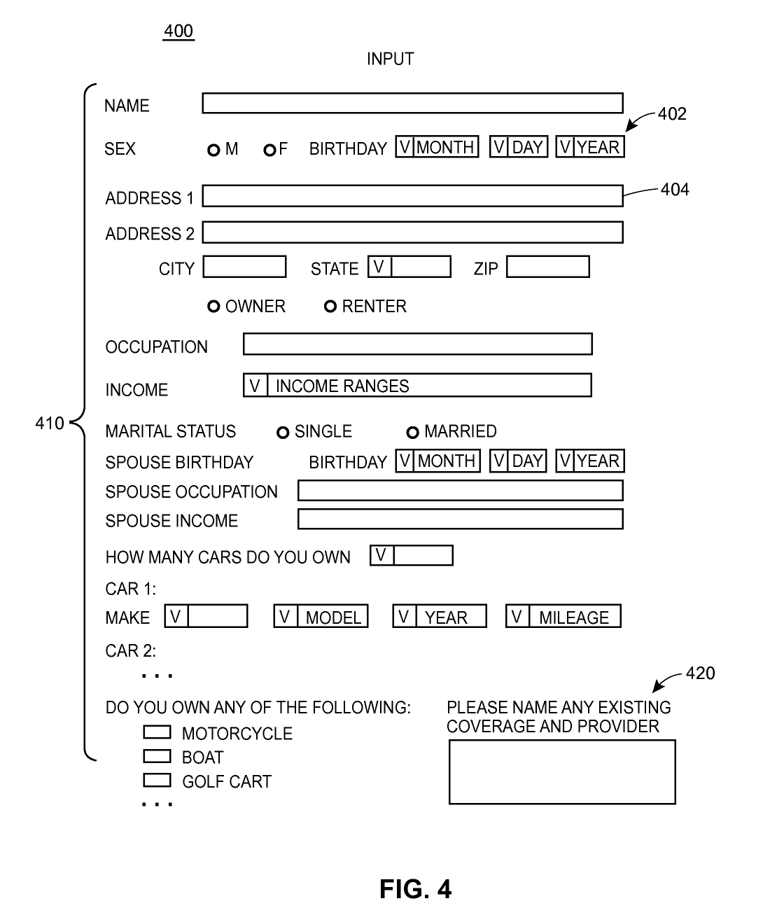

At function 301, the system 100 may execute an instruction to receive survey data 128 or other customer data, as described above in relation to FIG. 1 (e.g., via a computing device 108). In some embodiments, the system 100 may receive data over time and as new customers participate in the survey, become new customers, or data is otherwise received for the system 100. The system 100 may store data in the appropriate database (customer data 118a, other data 118b, historical data 118c, or third party data 118d) as it is received. With reference to FIG. 4, an exemplary user interface of a survey 400 for the bundle tool 112 may allow the system 100 to receive customer data 118a, survey data 128, other data 118b, historical data 118c, and third party data 118d. The system may receive the survey data 128 and, at function 302, send it to the backend where the data will analyzed and used to create bundle 119a recommendations, as described herein.

FIG. 4, as noted above, is an exemplary user interface of a survey 400 for the insurance bundle tool 112 which may allow the system 100 to collect customer data 118a, survey data 128, and other data 118b to be used in creating insurance bundles 119a. In some embodiments, the interface 400 may include a plurality of survey questions 410 some with selectable responses 402 and some with written responses 404. The questions may include a collection of statements that elicit corresponding responses 402 and 404. In some embodiments, using the interface includes a mix of demographic questions and insurance coverage questions which are relevant for creating insurance bundles. Demographics questions 410 may include a statement or question of facts about the customer such as age, residence zip code, income, etc. Insurance coverage questions 420 may include a statement or question of facts about the customer's current coverage such as insurance providers, extent of the coverage, deductibles, etc. Responses to questions 410 and 420 may allow the bundle tool 112 to use the received data to create relevant insurance bundles 119a for the user at the computing device 102.

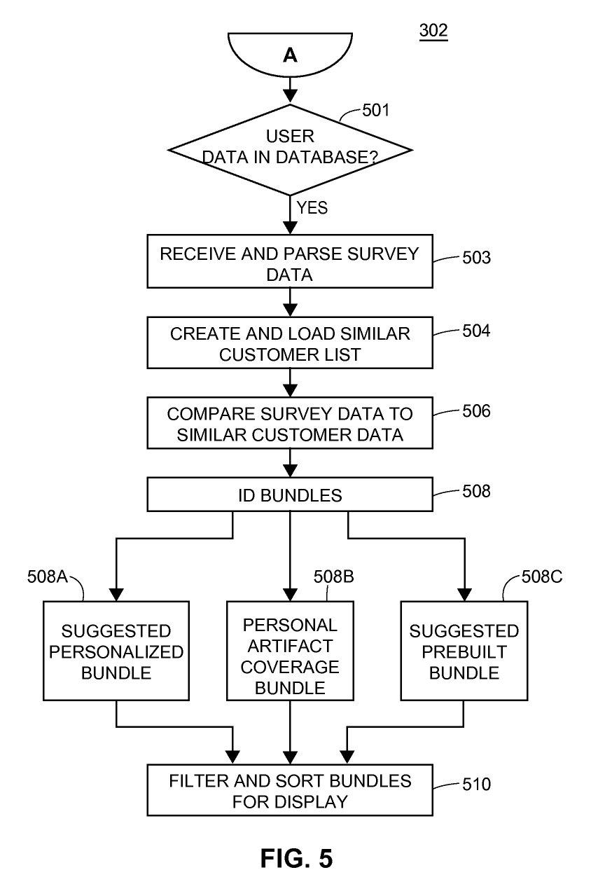

With reference to FIGS. 3 and 5, the system 100 may continue the method 300 from the method 302 of FIG. 3 above. Upon receiving the user survey data 128 from survey 400 the method 302 may then execute an instruction to query the customer data 118a, other data 118b, historical data 118c, and third party data 118d (function 501) to determine if there is additional information about the user available in the database. If information that is relevant to the bundle tool 112 about the user exists in customer data 118a or other data 118b, then at function 501 the information may be added to survey data 128. If the user is a returning customer, then relevant information for the bundle tool 112 about prior coverage, previous purchases, or other data may be available in historical data 118c and may be added to survey data 128. Similarly, function 501 may receive answers to insurance coverage questions 420 from the survey 400 which indicate that another insurance company provides coverage to the customer. The method may then query third party data 118d (function 501) for relevant information for the bundle tool 112 about current and previous third party insurance coverage which may then be added to survey data 128.

At function 503, the system 100 may execute an instruction to collect relevant user data from survey data 128, which may include information from the survey 400, user data 118, other data 118b, historical data 118c, and third party data 118d. For example, function 503 may include an instruction to parse the data into categories to facilitate analysis of the data.

At function 504, the system 100 may execute an instruction to create and load a similar customer list 130 (FIG. 1). For example, function 504 may include an instruction to compare the data that was received and parsed at function 503 to data about other customers located in customer data 118a, other data 118b, historical data 118c, and third party data 118d to identify similar customers. In further embodiments, the similar customer list 130 may be constructed using various techniques to show that a particular customer is similar to one or more other customers, and therefore might be interested in insurance coverage that the other customers use. Particular to the bundle recommendation methods disclosed herein, it may be advantageous to identify customers with similar demographic data among the various customer data stored by the system 100. A list of similar customers in conjunction with a list of insurance coverage purchased by those similar customers may be used to identify coverage to recommend to the user, as discussed herein. The bundle tool 112 may then execute an instruction to identify the most popular coverage types among the customers on the similar customer list 130 to be used when creating insurance bundles 119a. In some embodiments, the most popular policies and coverage types may be identified by counting a frequency of the number and type of policy carried by each customer. Those types of policies having the highest number of customers that are also similar to the user will be candidates for an insurance bundle.

Function 504 may include an instruction to generate the similar customer list 130 using some or all of the survey data 128 previously received. For example, function 504 may include an instruction to analyze the customer data 118a and survey data 128 with one or more algorithms to produce a similar customer list 130. The algorithms may include collaborative filtering, cluster models, search-based filtering, for example.

At function 506, the system 100 may then execute instructions to compare the parsed survey data 128 from function 503 to the similar customer list 130 created at function 504. As mentioned above, the bundle tool 112 may include instructions to identify which types of coverage are most popular among the similar customer list 130 to be used to create insurance bundles 119a and store them in the bundle repository 119. The bundle tool 112 may also include an instruction to use other data 118b in the creation of bundles 119a. Similarly, the bundle tool 112 may include an instruction to search the bundle repository 119 for existing bundles 119a that match a user's needs and are appropriate for recommendation.

Once the method 302 creates the insurance bundles 119a, the bundle tool 112 may execute an instruction (function 508) to identify recommended insurance bundles 119a. Insurance bundles 119a may be geared towards many types of coverage including suggested personalized bundles (508a), personal artifact coverage bundles (508b), and suggested prebuilt bundles (508c) to name only a few examples.

At function 510, the system 100 may execute an instruction to filter and sort the bundles 119a for display to the user. In some embodiments, the bundles may be sorted by relevance to the user's needs. For example if survey data 128 indicates that a user is an owner of an automobile, insurance bundles 119a that include auto insurance may be recommended over bundles 119b that do not. Furthermore, other factors such as the bundle 119a price or the users purchase history, for example, can be used to sort bundles 119a. The bundle tool 112 may then execute an instruction to prepare the sorted list for presentation in a GUI 110 on a web browser 114 to a customer using a computing device 108 via communication link 106.

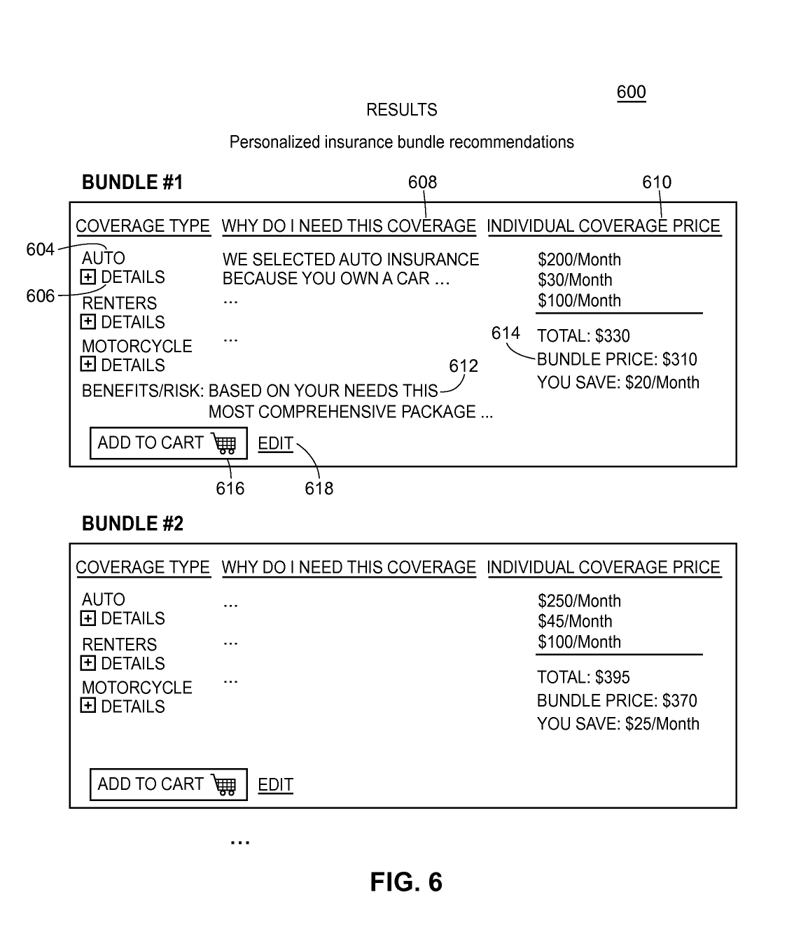

Returning to FIG. 3, once the system 100 executes the method 302, the process of method 300 continues at function 303. At function 303, the system 100 may execute an instruction to display the bundle recommendations to the user on a device 108 in a GUI 110 on a website 114. FIG. 6 illustrates an exemplary user interface 600 for a bundle recommendation page. Once the system displays the bundles 119a to the user, the system 100 may present an option to edit a bundle 119a (function 304). If the system receives an indication that the user has chosen to edit a bundle 119a, the method 300 may proceed to an editing method 305.

If the system 100 does not receive an indication that the user chose to edit any of the bundles at function 304, the system may execute an instruction (function 306) to present a bundle 119a for purchase. The function 303 may execute an instruction to have the bundle tool 112 present the bundle 119a recommendations in a GUI 110 on a web browser 114 to a customer using a computing device 108 via communication link 106 (e.g., user interface 600 of FIG. 6). In some embodiments the interface 600 may include a plurality of presented bundles 602. The presented bundles 602 may display the coverage types 604 included in the bundle. For example, auto insurance may be a type of coverage 604 included in the bundle 119a. The presented bundle 602 may also include a plurality of information about the coverage type 604 such as specific details about the coverage 606 (deductible, liability coverage, etc.), a reason 608 that the coverage 604 is included in the bundle 119a, and the individual price 610 of the coverage type 604.

The system 100 may also execute instruction to display additional information about the bundle 119a in the presented bundle 602. For example, the presented bundle 602 may include a risk analysis 612 describing the extent of the coverage provided by the bundle 119a, and the risks associated with a customer not purchasing elements of the coverage. The total price 614 of the bundle 119a may also be included in the presented bundle 602. The presented bundle 602 may present the information described herein in combination with other information to provide the customer with the most complete overview of the bundle 119a.

Once the system 100 executes an instruction to display the recommended bundles (function 303), the method 300 may wait for the user to decide the next step. Referring to the exemplary interface in FIG. 6, The presented bundle 602 may allow the user a choice to either purchase 616 or edit 618 the bundle 119a.

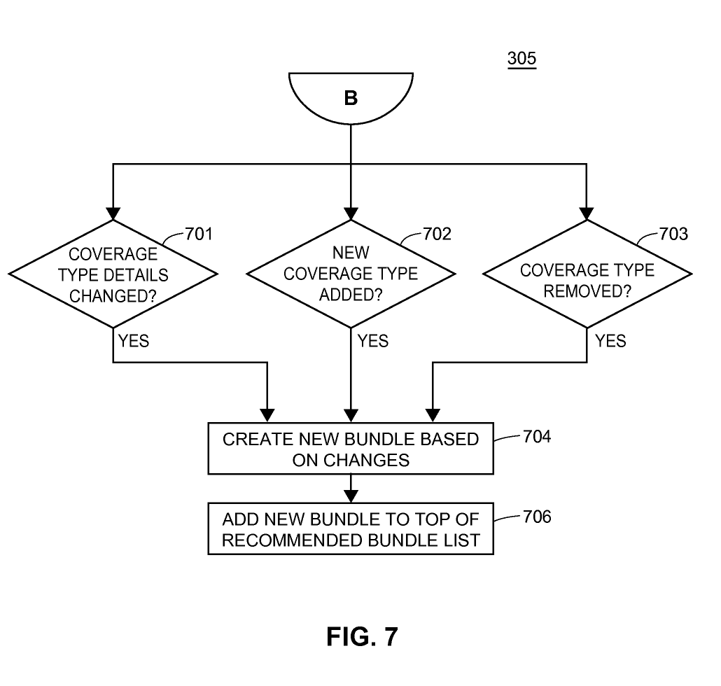

Referring now to FIG. 7, the editing method 305 may be a continuation of the method 300, should a user choose to edit a bundle 119a. The method 700 may display an interface to allow the user to edit a plurality of aspects of the bundle 119a.

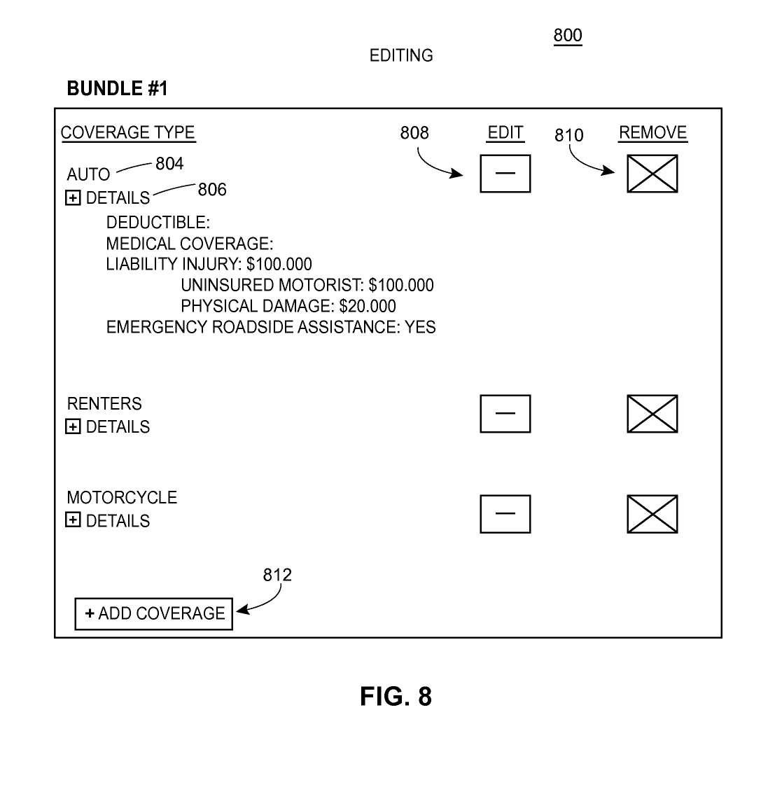

FIG. 8 illustrates an exemplary user interface 800 for editing bundle packages 119a. The interface 800 may display the bundle 119a in a manner similar to that of interface 600. The interface 800 may display coverage type 804 and details about the coverage 806 (i.e. deductible, liability coverage, etc.). The user interface 800 may also display an option for users to edit the coverage type details 808. The user interface may also have an option for users to completely remove a coverage type 810. Furthermore the user interface may also have an option to add additional coverage types 812. The interface 800 may include the various functions described herein in combination with other editing functions to allow the user maximum freedom in editing the bundle 119a.

Returning to FIG. 7, the method 305 may execute an instruction to determine if the user has changed any details of a coverage type at function 701. For example, a user may use the interface 800 to decide to raise the deductible on an auto insurance policy included in a bundle 119a.

At function 702 the method may execute an instruction to determine if the user indicated to add a coverage type to the bundle 119a using the interface 800. For example, a user might want to add life insurance to a bundle 119a that does not include life insurance. Furthermore, at function 703 the method may execute an instruction to determine if a user has decided to remove a coverage type using the interface 800. For example, a user may want to remove auto insurance from the bundle 119a because they plan on selling their car in the near future.

At function 704 the method may execute an instruction to receive any edits made by the user and implement them. In some embodiments, function 704 includes an instruction to use the bundle tool 112 to create a new insurance bundle 119a. The method may execute an instruction to receive edits described herein in combination with other edits to create a new bundle 119a. If no edits were made, then the method may execute an instruction to return the bundle 119a unchanged. If the user does make edits to the bundle 119a, at function 706 may execute an instruction to place the newly created bundle 119a on top of the recommended bundle list and prepare the list for presentation to the user within the user interface 600. The method may then execute an instruction to return to block 303 from FIG. 3 above and present the newly created bundle 119a.

FIG. 9 illustrates an exemplary computing environment for implementing the system 100 and methods 300, 305, and 302, as described herein. As shown in FIG. 9, the computing device 901 includes a processor 902 that is coupled to an interconnection bus 904. The processor 902 includes a register set or register space 906, which is depicted in FIG. 9 as being entirely on-chip, but which could alternatively be located entirely or partially off-chip and directly coupled to the processor 902 via dedicated electrical connections and/or via the interconnection bus 904. The processor 902 may be any suitable processor, processing unit or microprocessor. Although not shown in FIG. 9, the computing device 901 may be a multi-processor device and, thus, may include one or more additional processors that are identical or similar to the processor 902 and that are communicatively coupled to the interconnection bus 904.

The processor 902 of FIG. 9 is coupled to a chipset 908, which includes a memory controller 912 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 908. The memory controller 912 performs functions that enable the processor 902 (or processors if there are multiple processors) to access a system memory 914 and a mass storage memory 916.

The system memory 914 may include any desired type of volatile and/or non-volatile memory such as, for example, static random access memory (SRAM), dynamic random access memory (DRAM), flash memory, read-only memory (ROM), etc. The mass storage memory 916 may include any desired type of mass storage device. For example, if the computing device 901 is used to implement a bundle tool application 918 having an API 919 (including functions and instructions as described by the method 300 of FIG. 3), and user interface 110 to receive user input, the mass storage memory 916 may include a hard disk drive, an optical drive, a tape storage device, a solid-state memory (a flash memory, a RAM memory, etc.), a magnetic memory (e.g., a hard drive), or any other memory suitable for mass storage. In one embodiment, non-transitory program functions, modules and routines (an application 918, an API 919, and the user interface 110, etc.) are stored in mass storage memory 916, loaded into system memory 914, and executed by a processor 902 or can be provided from computer program products that are stored in tangible computer-readable storage mediums (RAM, hard disk, optical/magnetic media, etc.). Mass storage 916 may also include a cache memory 921 storing application data, user profile data, and timestamp data corresponding to the application data, and other data for use by the application 918.

The peripheral I/O controller 910 performs functions that enable the processor 902 to communicate with peripheral input/output (I/O) devices 922 and 924, a network interface 926, via a peripheral I/O bus 928. The I/O devices 922 and 924 may be any desired type of I/O device such as a keyboard, a display (a liquid crystal display (LCD), a cathode ray tube (CRT) display, etc.), a navigation device (a mouse, a trackball, a capacitive touch pad, a joystick, etc.), etc. The I/O devices 922 and 924 may be used with the application 918 to provide a bundle tool 112 and web interface 400 as described in relation to the figures. The local network transceiver 928 may include support for Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 912 and the I/O controller 910 are depicted in FIG. 9 as separate functional blocks within the chipset 908, the functions performed by these blocks may be integrated within a single integrated circuit or may be implemented using two or more separate integrated circuits. The system 900 may also implement the user interface 400 and bundle tool 112 on remote computing devices 930 and 932. The remote computing devices 930 and 932 may communicate with the computing device 901 over a network link 934. For example, the computing device 901 may receive survey data 128 created by an application executing on a remote computing device 930, 932. In some embodiments, the application 918 including the user interface 400 and tool 112 may be retrieved by the computing device 901 from a cloud computing server 936 via the Internet 938. When using the cloud computing server 936, the retrieved application 918 may be programmatically linked with the computing device 901. The bundle tool application 918 may be a Java® applet executing within a Java® Virtual Machine (JVM) environment resident in the computing device 901 or the remote computing devices 930, 932. The application 918 may also be “plug-ins” adapted to execute in a web-browser located on the computing devices 901, 930, and 932. In some embodiments, the application 918 may communicate with backend components 940 such as the data system 104 via the Internet 938 or other type of network.

Using the system 100 and method 300 described herein, a bundle tool 112 and interface 400 coupled with the method 300 may implement an insurance bundle creation methodology to better service, retain, and expand a business' customer base. By implementing the creation of bundles by the tool 112, customers may have access to complete insurance coverage that is simple and quick. In an insurance business, this bundle tool may help cater to the needs of customers while also providing a new avenue for sales. For example, a customer searching solely for auto insurance may purchase a bundle presented to them due to convenience and overall cost savings of the bundle, which in turn results in additional sales for the insurance provider.

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 112, may include but is not limited to any combination of a LAN, a MAN, a WAN, a mobile, a wired or wireless network, a private network, or a virtual private network. Moreover, while only one client computing device is illustrated in FIG. 1 to simplify and clarify the description, it is understood that any number of client computers or display devices are supported and can be in communication with the data system 104.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain functions. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, which may be one of an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors). These operations are accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computer system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for creating and presenting insurance bundles through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for creating a bundle of different insurance policies for a particular customer based on data corresponding to the particular customer, the method comprising:
receiving, via a computer network, survey data that includes data corresponding to the particular customer including responses to demographics questions and insurance coverage questions;
comparing, with one or more processors, the received survey data to historical customer data, wherein historical customer data includes information corresponding to a plurality of customers of an insurance provider;
creating, with one or more processors, a similar customer list based on the comparison of the received survey data to the historical customer data, the similar customer list including a one or more customers from the historical customer data that each correspond to one or more insurance policies purchased by the corresponding customer;
identifying, with one or more processors, one or more insurance bundles, each insurance bundle including at least two insurance policies, wherein the insurance policies of the insurance bundle correspond to insurance policies purchased by one or more customers of the similar customer list;
determining a relevance to the particular customer for each of the one or more insurance bundles, wherein determining the relevance to the particular customer includes analyzing the similar customer list to determine one or more of popularity among the similar customer list of the one or more insurance policies that comprise each insurance bundle, or price of the insurance bundle; and
presenting the insurance bundles for one or more of a purchasing operation or an editing operation, wherein presenting the insurance bundles includes presenting a plurality of insurance bundles in a list sorted by the determined relevance to the particular customer, and wherein relevance to the particular customer further includes a correspondence of the plurality of insurance bundles to the survey data.

2. The computer-implemented method of claim 1, wherein survey data is further received through one or more databases of customer information.

3. (canceled)

4. (canceled)

5. (canceled)

6. The computer-implemented method of claim 1, further comprising editing the presented insurance bundle, wherein editing the insurance bundle includes one or more of adding a coverage type, removing a coverage type, or changing a coverage type detail.

7. The computer-implemented method of claim 1, further comprising selecting the presented insurance bundle from a set of pre-created bundles.

8. An insurance bundling system configured to create a bundle of different insurance policies for a particular customer based on data corresponding to the particular customer, the system comprising:
a data system server including one or more processors and one or more memories, the memories including instructions executed on the one or more processors to:
receive survey data that includes data corresponding to the particular customer including responses to demographics questions and insurance coverage questions;
compare the received survey data to historical customer data, wherein historical customer data includes information corresponding to a plurality of customers of an insurance provider;
create a similar customer list based on the comparison of the received survey data to the historical customer data, the similar customer list including one or more customers from the historical customer data that each correspond to one or more insurance policies purchased by the corresponding customer;
identify one or more insurance bundles, each insurance bundle including at least two insurance policies, wherein the insurance policies of the insurance bundle correspond to insurance policies purchased by one or more customers of the similar customer list;
determine a relevance to the particular customer for each of the one or more insurance bundles, wherein the instruction to determine the relevance to the particular customer includes an instruction to analyze the similar customer list to determine one or more of popularity among the similar customer list of the one or more insurance policies that comprise each insurance bundle, or price of the insurance bundle; and
present the insurance bundles for one or more of a purchasing operation or an editing operation, wherein the instruction to present the insurance bundles includes an instruction to present a plurality of insurance bundles in a list sorted by the determined relevance to, and wherein relevance to the particular customer further includes a correspondence of the plurality of insurance bundles to the survey data.

9. The computer system of claim 8, wherein survey data is further received through one or more databases of customer information.

10. (canceled)

11. (canceled)

12. (canceled)

13. The computer system of claim 8, further comprising an instruction to edit the presented insurance bundle, wherein the instruction to edit the insurance bundle includes one or more instructions to add a coverage type, remove a coverage type, or change a coverage type detail.

14. The computer system of claim 8, further comprising an instruction to select the presented insurance bundle from a set of pre-created bundles.

15. A tangible computer-readable medium including non-transitory computer readable instructions stored thereon for bundling different types of insurance policies based on data corresponding to a particular customer, the instructions to:
receive survey data that includes data corresponding to the particular customer including responses to demographics questions and insurance coverage questions;
compare with one or more processors the received survey data to historical customer data, wherein historical customer data includes information corresponding to a plurality of customers of an insurance provider;
create with one or more processors a similar customer list based on the comparison of the received survey data to the historical customer data, the similar customer list including one or more customers from the historical customer data that each correspond to one or more insurance policies purchased by the corresponding customer;
identify with one or more processors one or more insurance bundles, each insurance bundle including at least two insurance policies, wherein the insurance policies of the insurance bundle correspond to insurance policies purchased by one or more customers of the similar customer list;
determine a relevance to the particular customer for each of the one or more insurance bundles, wherein the instruction to determine the relevance to the particular customer includes an instruction to analyze the similar customer list to determine one or more of popularity among the similar customer list of the one or more insurance policies that comprise each insurance bundle, or price of the insurance bundle; and
present the insurance bundles for one or more of a purchasing operation or an editing operation, wherein the instruction to present the insurance bundles includes further instructions to present a plurality of insurance bundles in a list sorted by the determined relevance to the particular customer, and wherein relevance to the particular customer further includes a correspondence of the plurality of insurance bundles to the survey data.

16. The tangible computer-readable medium of claim 15, wherein the instruction to receive survey data comprises further instructions to receive the survey data through one or more databases of customer information.

17. (canceled)

18. (canceled)

19. (canceled)

20. The tangible computer-readable medium of claim 15, further comprising an instruction to edit the presented insurance bundle, wherein the instruction to edit the insurance bundle includes one or more instructions to add a coverage type, remove a coverage type, or change a coverage type detail.
